(19) United States
(12) Patent Application Publication
(10) Pub. No.: US 2005/0266187 A1
(43) Pub. Date: Dec. 1, 2005

(54) Blast resistant glass laminates having improved structural integrity against severe impacts

(76) Inventors: Charles Anthony Smith, Vienna, WV (US); Stephen J. Bennison, Wilmington, DE (US); David M. Rinehart, Wilmington, DE (US); James G. Sloan, Newark, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/013,510

(22) Filed: Dec. 15, 2004

Related U.S. Application Data
(60) Provisional application No. 60/529,914, filed on Dec. 15, 2003.

(51) Int. Cl. B32B 7/02

(52) U.S. Cl. 428/34

(57) ABSTRACT

This invention is a process of preparing a glazing structure that is a glass laminate having enhanced resistance to being pulled from a frame upon being subjected to high positive and/or negative pressure loads. This invention is particularly suitable for architectural structures having windows that can be subjected to the extreme conditions prevalent in a hurricane, bomb-blast event or placed under stress from repeated forceful blows to the laminate.

### CROSS REFERENCE TO RELATED APPLICATIONS

This application claims priority of U.S. Provisional Application No. 60/529,914, filed Dec. 15, 2003, which is incorporated by reference herein for all purposes as if fully set forth.

### BACKGROUND OF THE INVENTION

1. Field of the Invention

This invention relates to laminated glass structures. This invention particularly relates to laminated glass structures that can withstand severe impact and/or severe pressure loads even being supported in localized positions around the periphery of the glazing element or within the body of the glazing element.

2. Description of the Prior Art

Conventional glazing structures comprise a glazing element. Such glazing elements can comprise a laminate window, such as a glass/interlayer/glass laminate window. There are various glazing methods known and which are conventional for constructing windows, doors, or other glazing elements for commercial and/or residential buildings. Such glazing methods are, for example: exterior pressure plate glazing; flush glazing; marine glazing; removable stop glazing; and, silicone structural glazing (also known as stopless glazing).

For example, U.S. Pat. No. 4,406,105 describes a structurally glazed system whereby holes are created through the glazing element and a plate member system with a connection being formed through the hole.

Threat-resistant windows and glass structures are known and can be constructed utilizing conventional glazing methods. U.S. Pat. No. 5,960,606 ('606) and U.S. Pat. No. 4,799,376 ('376) each describes laminate windows that are made to withstand severe forces. In International Publication Number WO 98/28515 (IPN '515) a glass laminate is positioned in a rigid channel in which a resilient material adjacent to the glass permits flexing movement between the resilient material and the rigid channel. Other means of holding glazing panels exist such as adhesive tapes, gaskets, putty, and the like can be used to secure panels to a frame. For example, WO 93/002269 describes the use of a stiffening member which is laminated to a polymeric interlayer around the periphery of a glass laminate to stiffen the interlayer, which can extend beyond the edge of the glass/interlayer laminate. In another embodiment, '269 describes the use of a rigid member which is inserted into a channel below the surface of a monolithic transparency, and extending from the transparency.

Windows and glass structures capable of withstanding hurricane-force winds and high force impacts are not trouble-free, however. Conventional glazing methods can require that the glazing element have some extra space in the frame to facilitate insertion or removal of the glazing element. While the additional space facilitates installation, it allows the glazing element to move in a swinging, rocking, or rotational motion within the frame. Further, it can move from side to side (transverse direction) in the frame depending upon the magnitude and direction of the force applied against the glazing element. Under conditions of severe repetitive impact and/or continuous pressure, a glass laminate can move within the frame or structural support in such a way that there can be sufficient stress built up to eventually fracture the window and allow the laminate to be pulled out of the frame. For example windows wherein glass is held within a rigid channel, when subjected to severe hurricane force winds, can be pulled out of the channel resulting in loss of integrity of the structure.

Existing glazing support structures, for example window frames, frequently do not adequately retain high performance glazings either due to frame distortion/failure or inability to prevent loss of capture. The full value of the glazing is only achieved if complete integrity is maintained. Bomb-blast resistant glazing structures have been created generally from very thick multilayer constructions of glass and various interlayer products such as PVB or PC bonded with polyurethane. The corresponding framing must have substantial edge capture (overlap) with the glazing or during the pressure loading the glazing will be driven out of the opening. Alternatively, a muntin supporting lattice of metal members may be positioned directly behind the glazing to aid in reducing the flexure of the glazing. Any of these approaches have been expensive, difficult to practice and aesthetically are not pleasing. Large expanses of glazing have not been possible against such high threats.

It would be desirable to have a glazing system capable of withstanding severe sudden impacts and stresses that may be present under conditions of a bomb detonation.

### BRIEF DESCRIPTION OF THE DRAWINGS

FIG. 1 is a laminate of the present invention with corner attachments.

FIG. 2 depicts the corner an exploded view of the corner attachment.

FIG. 4 depicts four laminates that are assembled using the corner assembly units.

FIG. 5 is an exploded view of the corner unit.

FIG. 6 is a glazing element comprising an aluminum reinforced periphery to the glazing in an aluminum U-channel.

FIG. 7 is a glazing element having a molded retention foot to engage the frame.

FIG. 8 is a glazing element further comprising DuPont Spallshield™ on its rear surface.

FIG. 9 is another view of a glazing of the present invention held in a U-channel.

FIG. 10 is a depiction of monolithic ionomer glazing held in a frame.

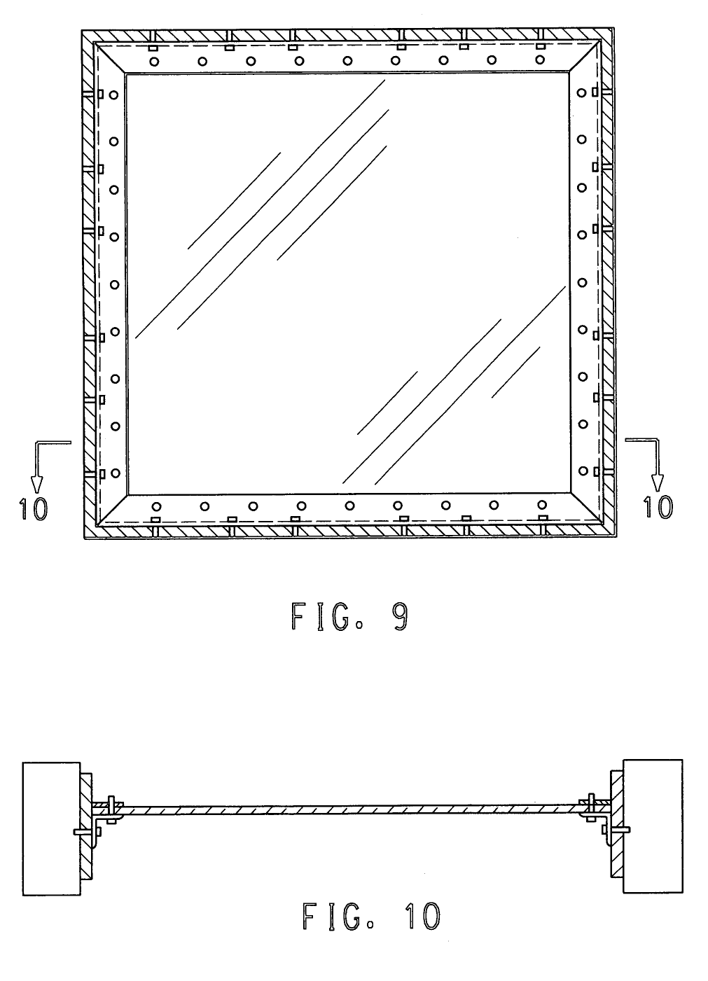

FIG. 11 is a cross-sectional view of the monolithic ionomer glazing.

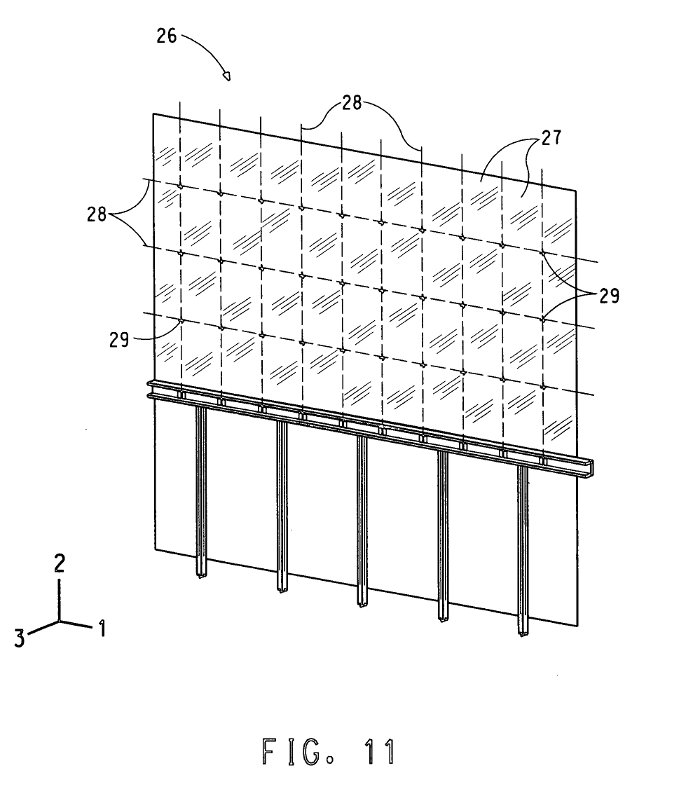

### SUMMARY OF THE INVENTION

In one aspect, the present invention is a glazing system comprising: a glass laminate glazing element; a support structure for the glazing element; and a connection system to attach the glazing element to the support structure, wherein the glazing element, the support structure, and the connection system are constructed to provide the glazing system with a dynamic response mechanism wherein after force impulse wave is applied to the glazing system, the connection system transfers a fraction of the force applied to the glazing element from the glazing element to the support structure, and wherein the support structure has some freedom of motion to enable the transferred portion of the externally applied force to be converted into non-destructive motions throughout the support structure, thereby decreasing the effective magnitude of the impulse experienced by the glazing element.

### DETAILED DESCRIPTION

In one embodiment, the present invention is a blast resistant glazing system comprising a glass laminate. The glass laminate of the present invention is a laminate that comprises at least one layer of an interlayer material, selected from materials in the group consisting of polyesters, polyvinyl chlorides, polyvinylacetals, polyurethanes, copolymers of ethylene and acrylic and/or methacrylic acid and salts thereof. The interlayer can comprise several layers of any one of these interlayer materials, or alternatively can comprise a mixture of two or more different layers of these interlayer materials. Laminates of the present invention can be conventional laminates of the type described in the glazing art and known for imparting shatter resistance to glass laminates and reducing glass spalling upon breakage.

The capacity of laminated glass to reduce the hazards associated with blast loading is primarily limited by four factors: 1) the interlayer tear energy, which influences the point at which the laminate ruptures, 2) interlayer adhesion, which influences the capacity to minimize glass spall, 3) the compliance of the laminate after glass fragmentation, which determines the dynamic response of the laminate and the associated tendency to pull-out from the glazing restraints, and 4) the mass of the laminate, which also effects the dynamic response. For a specified blast event, the laminate is optimized to just reach the tear limit of the polymer interlayer, without pulling out of the frame and minimizing the degree of glass spall.

While many conventional polymers can be suitable for use in the practice of the present invention, preferably the polymer is an ethylene copolymer. More preferably the thermoplastic polymer is a copolymer obtained by the copolymerization of ethylene and an α, β-unsaturated carboxylic acid, or derivatives thereof. Suitable derivatives of acids useful in the practice of the present invention are known to those skilled in the art, and include esters, salts, anhydrides, amides, and the like. Acid copolymers can be fully or partially neutralized to the salt (or partial salt). Fully or partially neutralized acid copolymers are known conventionally as ionomers. Suitable copolymers can include an optional third monomeric constituent which can be an ester of an ethylenically unsaturated carboxylic acid. Suitable acid copolymers useful in the practice of the present invention can be purchased commercially from, for example, E.I. DuPont de Nemours & Company under the tradenames of Surlyn® and Nucrel®, for example. Particularly preferred are laminates that are known to have improved resistance, relative to conventional glass laminates, to severe impacts such as from hurricane force winds and/or from debris that is carried by such winds. An interlayer of the present invention preferably has a Storage Young's Modulus of from about 50 to about 1,000 MPa (mega Pascals) and preferably form about 100 to about 500 MPa, as determined according to ASTM D 5026-95a. The interlayer should remain in the 50-1,000 MPa range of its Storage Young's Modulus at temperatures up to 40° C.

A laminate of the present invention can be directly or indirectly connected to the support structure of the glazing system. In a preferred embodiment, the laminate comprises an interlayer wherein a portion of the interlayer is extended beyond the periphery of the glass, and the extended portion can be used to attach the laminate to the support structure. Such laminates are fully described in U.S. patent application Ser. No. 09/551,334 incorporated herein by reference. Suitable laminates can be purchased commercially under various product names such as, for example, SentryGlass® Plus, available from E. I. DuPont de Nemours and Company.

The laminate can be connected to the support structure in a continuous manner along the perimeter of the laminate. Alternatively, the interlayer can be connected to the structural support in a discontinuous manner, that is, at intermittent and various points around the perimeter of the laminate. Any manner of connecting the laminate to the support structure by way of the interlayer is considered to be a suitable means of connecting the laminate to the support structure for the purposes of the present invention, and is within the scope of the present invention.

In the practice of the present invention the glazing element is said to be connected to the support structure if the glazing element is nailed, screwed, bolted, glued, slotted, tied or otherwise constrained from becoming detached from the support structure.

The performance of a laminate can be significantly influenced by the structural response of the supporting frame and details of the connection system. Blast loading (which is, for the purposes of the present invention, the force exerted on a glazing element by a detonation) by its nature is a highly dynamic event so the dynamic response of the glazing support and connection system play a strong role in how the laminate deforms in response to a given pressure/impulse load. The invention is that the performance of the laminate may be significantly extended or improved against severe forces through modifications of the system and connection response to dynamic loading. By effectively softening the glazing support system and delaying the time before full engagement of the connection system, the laminate is effectively shielded from the full pressure/impulse load and the whole transparent facade performance is improved.

As contemplated in the practice of the present invention, a support structure is a structural element that supports or holds the glazing element in place. Direct attachment of the interlayer to the support can be from the top, sides, bottom, or through the interlayer material.

The glazing system can optionally comprise a retaining assembly which functions to hold the glazing element in place against a mullion. A retaining assembly of the present invention is specifically designed to retain a laminate of the present invention by way of the connecting system of the laminate. A retaining assembly of the present invention can be internal to the mullion or external to the mullion. A retaining assembly of the present invention can be a clamp assembly, a cap assembly, or other type of assembly which provides a method of retaining a glazing element of the present invention in a framing structure, with the proviso that the retaining assembly is not visible to an observer when the glazing element is completely assembled. A retaining assembly can comprise a fastener which functions to hold the retaining assembly to the mullion.

The laminate can comprise an attachment means wherein attachment means is a clip that can be bonded to the extended portion of the interlayer. In the practice of the present invention there is no direct contact intended between the clip and any portion of the glass layer(s) of the laminate, and any such contact is incidental. Contact between the clip and the glass is to be minimized to reduce glass fracture under stress or during movement of the laminate in the support structure. To that end, the portion of the interlayer that extends from the edges of the laminate forms an intervening layer between the clip and the glass layer such that the clip does not contact the glass. The surface of the clip that contacts the interlayer can be smooth, but preferably the surface of the clip has at least one projection and/or one recessed area, and more preferably several projections and/or recessed areas, which can provide a mechanical interlocking mechanism to enhance the effectiveness of the adhesive bonding between the clip and the interlayer, thereby providing a laminate/clip assembly with greater structural integrity.

Any number of laminates can be constructed in such a fashion as to form a wall of laminates.

For architectural uses and for uses in transportation applications such as automobiles, trucks and trains, a laminate can have two layers of glass and, self-adhered to the glass, an interlayer of a thermoplastic polymer. A laminate of the present invention can have an overall thickness of about 3-30 mm. The interlayer can have a thickness of about 0.38-4.6 mm and each glass layer can be at least 1 mm thick. In a preferred embodiment, the interlayer is self-adhered directly to the glass, that is, an intermediate adhesive layer or coating between the glass and the interlayer is not used. Other laminate constructions can be used such as, for example, multiple layers of glass and thermoplastic interlayers; or a single layer of glass with a thermoplastic polymer interlayer, having adhered to the interlayer a layer of a durable transparent plastic film. Any of the above laminates can be coated with conventional abrasion resistant coatings that are known in the art.

A frame can be selected from the many available frame designs in the glazing art. The laminate can be attached, or secured, to the frame with or without use of an adhesive material. It has been found that an interlayer made from ionomer resin self-adheres securely to most frame materials, such as wood, steel, aluminum and plastics. In some applications it may be desirable to use additional fasteners such as screws, bolts, and clamps along the edge of the frame. Any means of anchoring the attachment means to the frame is suitable for use in the present invention.

### EXAMPLES

The Examples are for illustrative purposes only, and are not intended to limit the scope of the invention.

### General Example

### General Glazing Preparation Procedure

Glazing structures of the present invention were prepared according to the following procedure:

Glass sheets (10 mm thick—fully tempered) 5 feet by 7 feet were washed with deionized water and dried. Ionomer resin sheeting (2.3 mm) thick with a surface texture applied to allow for ease of air removal to improve the clarity and ‘bubble-point’ of the laminate was laid between the two lites of glass. All laminates in these examples used 2 layers of 90 mil (2.3 mm) thick interlayer of an ionomer resin composed of 81% ethylene and 19% methacrylic acid that has been 37% neutralized with sodium ion and having a melt index of 2, and 2 layers of glass each 10 mm in thickness. The interlayer thickness can be adjusted, either by extrusion of differing thickness sheets or multiple sheets can be utilized together to increase the glazing members tear strength for a given expected threat-level as is done conventionally in the industry. The ionomer resin is available commercially from E. I. Du Pont de Nemours and Company. The ionomer resin interlayer has a Storage Young's Modulus of 361 MPa, Tear Energy of 101 MJ/m³ and an adhesion to glass of 24 MPa, all measured at 25° C. Depending on the particular shape/profile or attachment desired, additional strips of the interlayer material was used around the periphery of the glazing element to allow for a means of retention and/or attachment.

### Examples 1-4

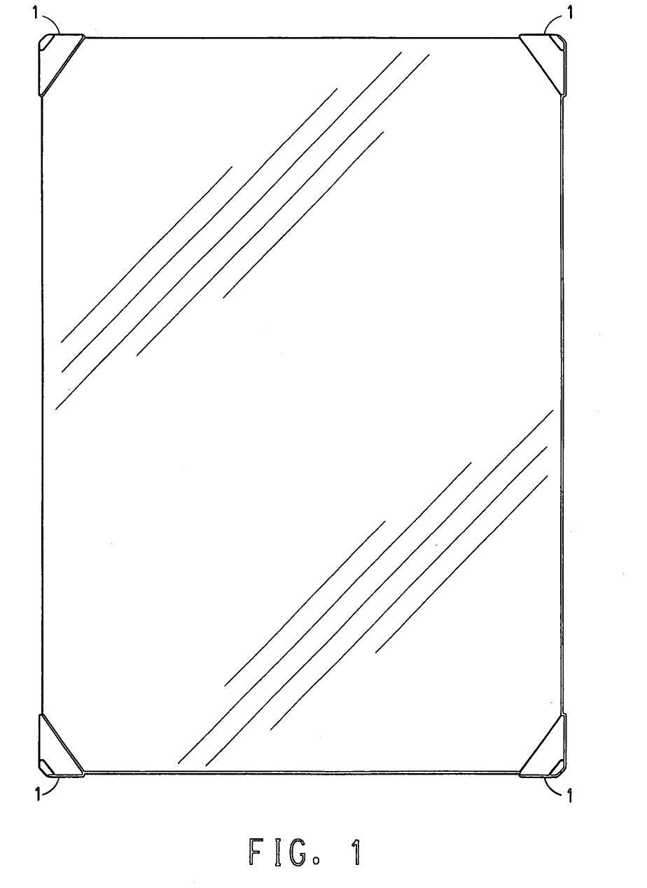

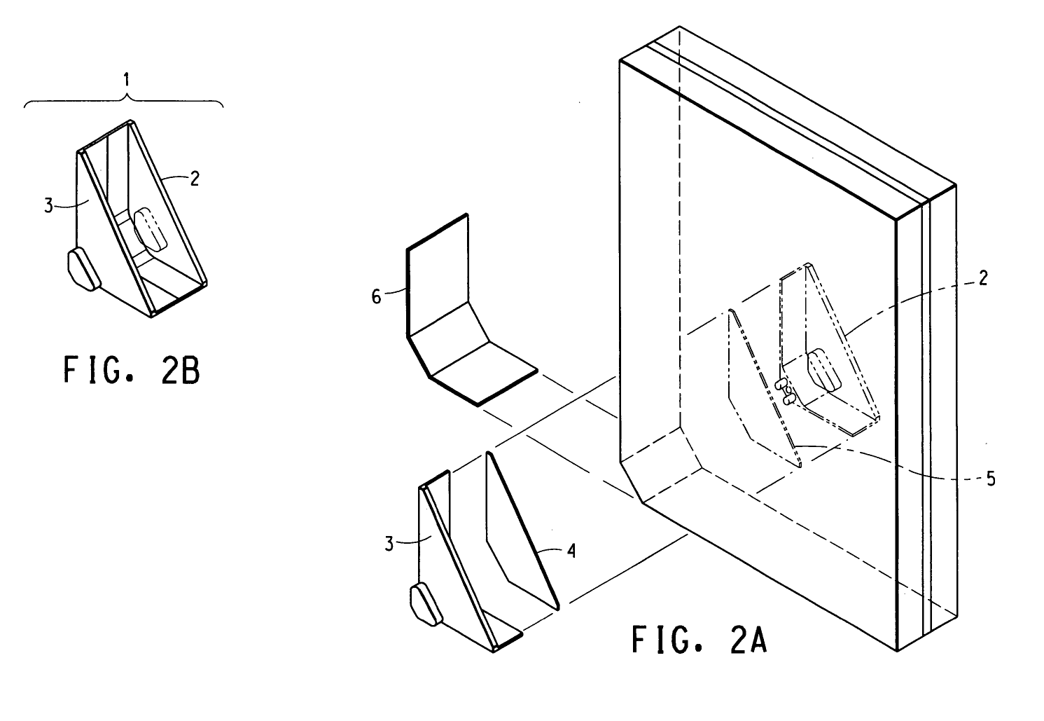

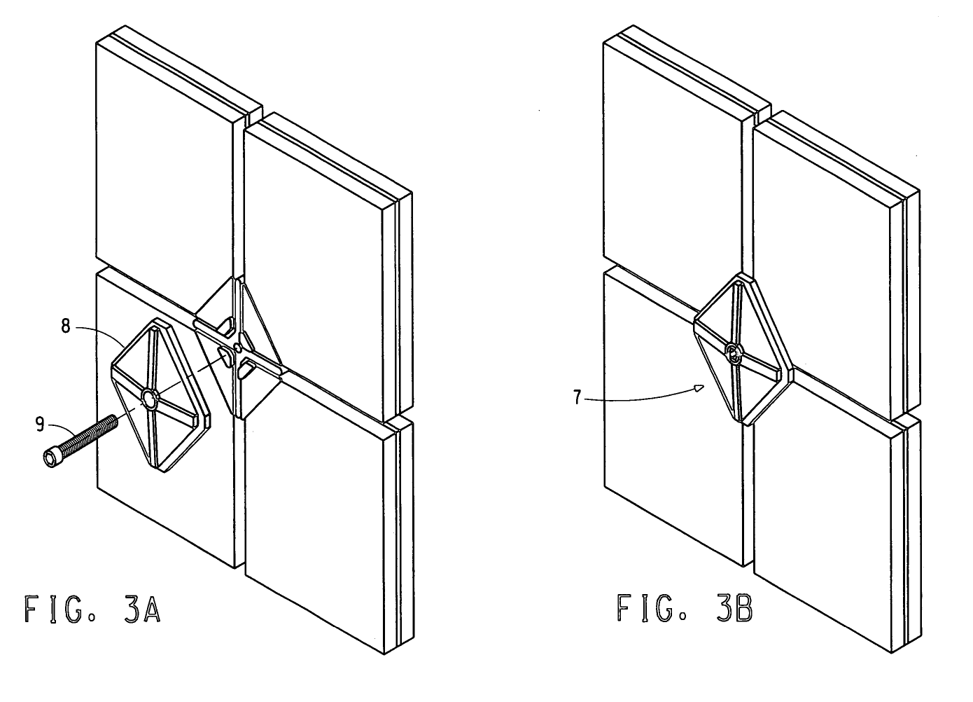

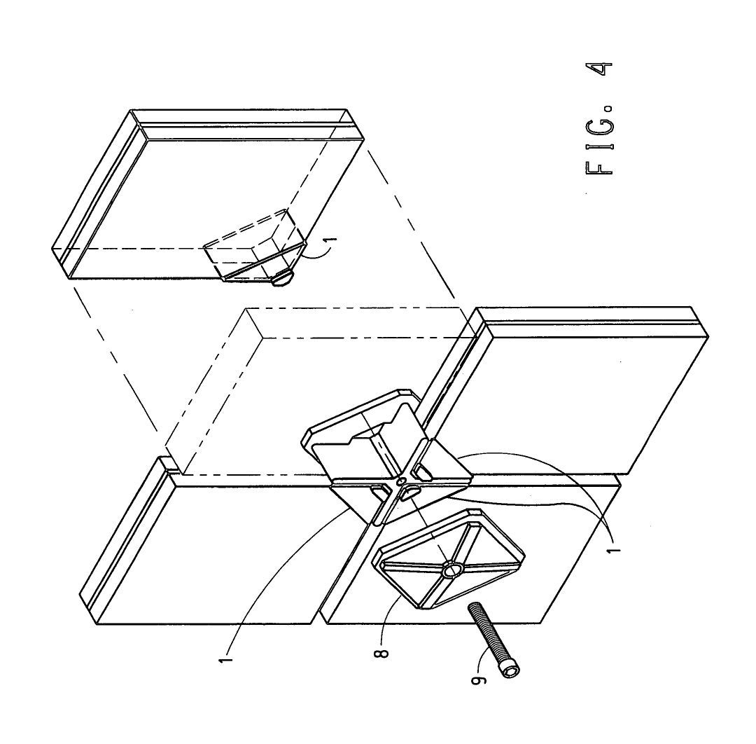

Metal corner pieces as shown in FIGS. 1 through 5 were prepared and were placed onto each corner of the laminate after placing a layer of the interlayer material in between the edge of the glass and the backplane of the metal ‘box’ to allow for substantial contact and bonding to occur. Laminates were then vacuum-bagged using conventional industrial methods, by applying a vacuum thereby removing a large portion of the air from the intervening spaces and the laminates were then placed into an air autoclave at 220 PSIG (1.6 MPa) pressure at 135° C. for 90 minutes.

TABLE 1

| | Applied Threat | Pressure | Impulse | Performance | Protection | Hazard |
|---|---|---|---|---|---|---|
| Ex | Level | (psi) | (psi-msec) | Condition | Level | Level |
| 1 | GSA Level C | 4.0 | 28 | 2 | Very High | None |
| 2 | EXV25 | 11.6 | 55 | 3a | High | Very Low |
| 3 | GSA Level C | 4.0 | 28 | | | |
| | Followed by | | | | | |
| | Second Blast | 6.8 | 67 | 3a/3b | High | Low |
| 4 | GSA Level D | 10 | 98 | 5 | Low | High |

Note: Test results and assessment based on Government Services Administration (GSA) Bomb-blast criterion.

TABLE 2
GSA Criteria for Test Specimen Performance Conditions

| | | Glass Fragments | | | |
|---|---|---|---|---|---|
| Performance | | Exterior to | Interior to | Hazard | Protection |
| Condition | Description | Structure | Structure | Level | Level |
| 1 | Glass not cracked, fully | None | None | NA | Very High |
| | survived and/or fully | | | | |
| | retained by frame and | | | | |
| | no glass fragments | | | | |
| | either inside or outside | | | | |
| | structure. | | | | |
| 2 | Glass may be cracked | Yes | No significant fragments. | Very Low | Very High |
| | but is retained by the | | Dusting or very small | | |
| | frame. | | fragments near sill or on | | |
| | | | floor acceptable. | | |
| 3a | Glass failed and not fully | Yes | Yes - land on floor no more | Low | High |
| | retained in frame. | | than 40 inches from window | | |
| 3b | Glass failed and not fully | Yes | Yes - land on floor no more | Low | High |
| | retained in frame. | | than 10 ft from window. | | |
| 4 | Glass failed and not fully | Yes | Yes - Land on floor more | Medium | Medium |
| | retained in frame. | | than 10 ft from window and | | |
| | | | impact a vertical surface | | |
| | | | located not more than 10 ft | | |
| | | | behind the window no | | |
| | | | higher than 2 ft above floor | | |
| | | | level. | | |
| 5 | Glass fails | Yes | Yes - land on floor more | High | Low |
| | catastrophically. | | than 10 ft from window and | | |
| | | | impact a vertical surface not | | |
| | | | more than 10 ft behind | | |
| | | | window above a height of 2 | | |
| | | | ft. | | |

[image]

### Examples 5-10

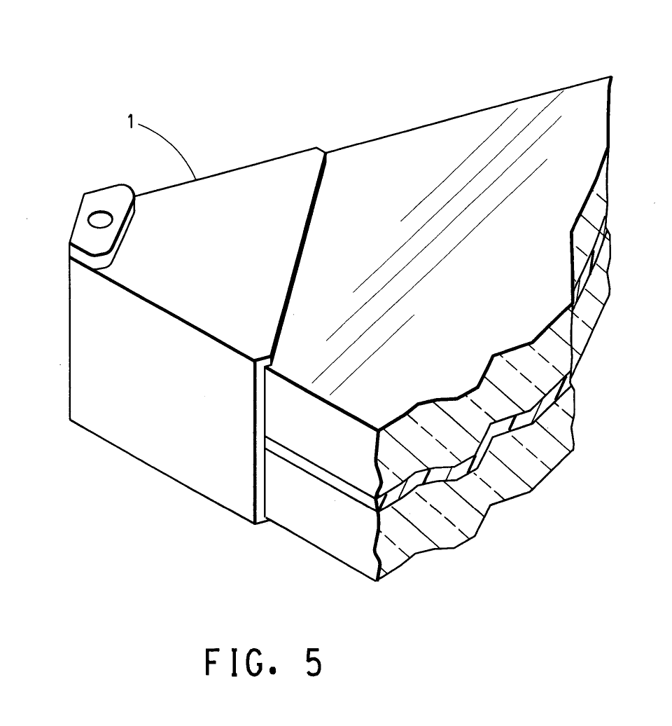

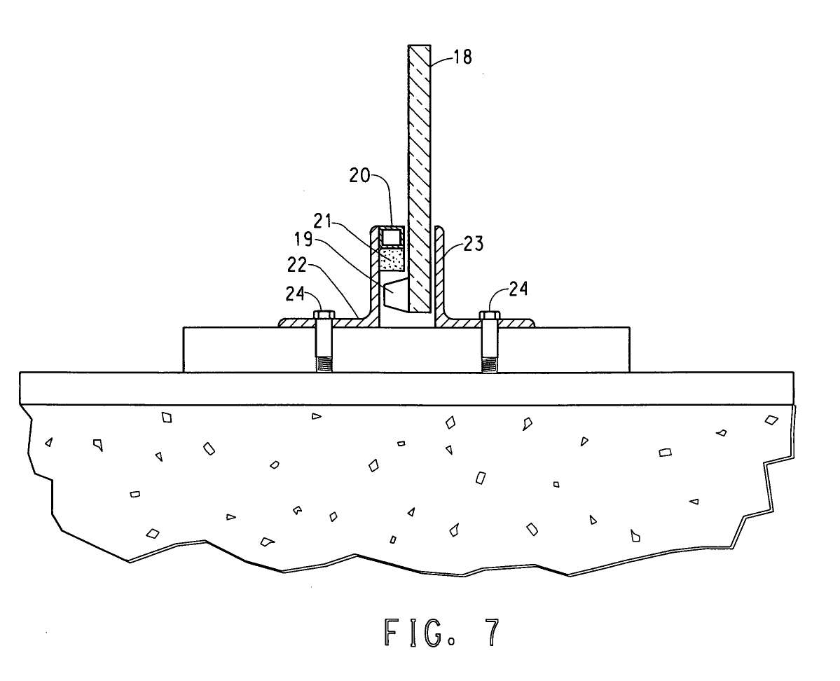

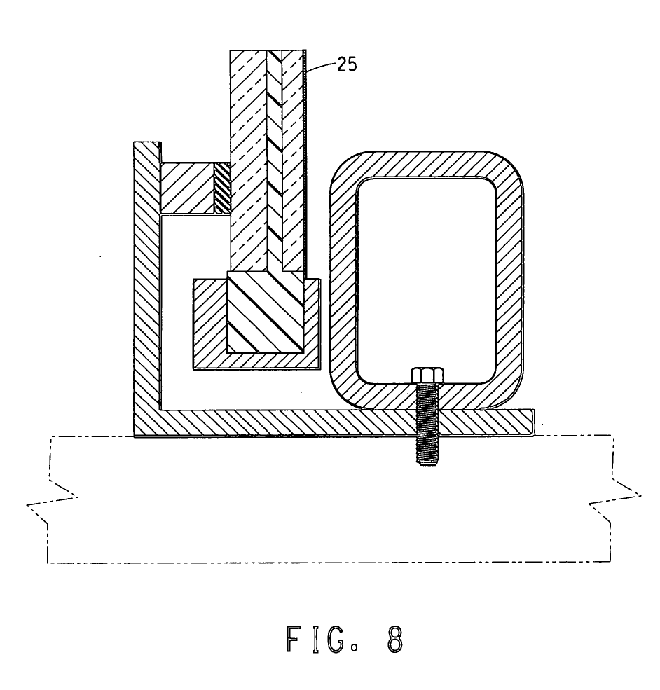

The glass of the laminates of Table 3 was prepared in the same manner as in Example 1. Glass used in these examples was 3 mm in thickness and annealed. The size of the samples were 42″×70″ and either 2 layers or 3 layers of 2.3 mm ionomer resin sheet was utilized depending on choice and the expected threat level. Additional ionomer resin along with two aluminum angles were positioned around the full periphery of the glazing elements as shown in FIGS. 6-9. These samples were vacuum bagged by conventional means at a relatively full vacuum was applied (absolute pressure below 50 torr). The sample was then placed into a convection oven and heated to 135° C. for a period of 2 hours while under vacuum. Cooling was then achieved by use of a large floor fan blowing room temperature air over the sample. After cooling (typically 30 minutes or so) the vacuum bag was removed yielding a fully laminated glazing element along with achieving a bond between the addition ionomer resin around the perimeter and encapsulating the aluminum angles/channels.

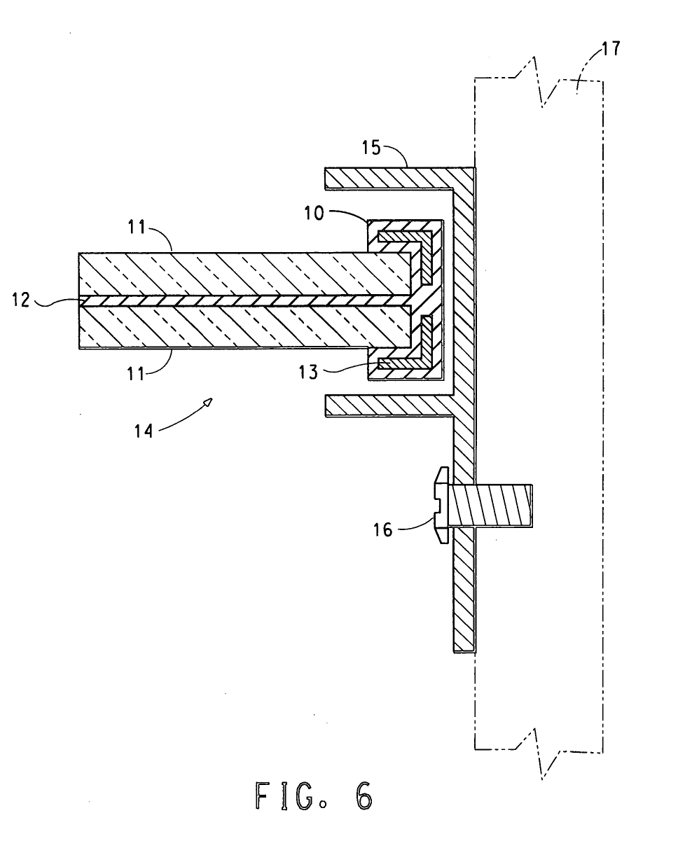

Another sample was prepared as a shaped profile of ionomer resin was created as shown in FIG. 7 this being done to provide a positive retention means by engaging with the frame and support structure as shown in FIG. 7. The same vacuum bagging and oven heating approaches were utilized to form both the glazing element lamination and positive retention system in a single process step.

Additional samples were prepared using an aluminum U-channel around the perimeter of the glazing element to again form a means of positive retention far exceeding conventional approaches of gaskets, tapes, or sealants (e.g. silicones).

Table 3 provides the results of testing various designs of blast resistant glazing in bomb blast tests.

TABLE 3

| EXAMPLE | Impulse (psi-msec) | Pressure (psi) | |
|---|---|---|---|
| (Modified Glazing | Exterior | Exterior | Interior |
| Description) | (threat) | (threat) | (occupant) |
| 5 (Ionomer/Aluminum | 313 | 72.4 | 0.8 |
| Angle Perimeter) | | | |
| 6 (Molded Ionomer | 212 | 35.1 | 1.2 |
| Retention ‘Foot’) | | | |
| 7 (Aluminum U-channel | 189 | 31.8 | 0.6 |
| with Ionomer) | | | |
| 8 (Aluminum U-channel | 213 | 33.2 | 1.0 |
| with Ionomer) | | | |
| 9 (Aluminum U-channel | 208 | 27.6 | 0.6 |
| with Ionomer) | | | |
| 10 (no glass/monolithic | | | |
| ionomer resin sheet) | | | |

### Example 11

A blast resistant cable-net wall support system connected to tiles of SentryGlas® Plus laminates using Secure™ connections in which engagement in the frame is modified to build in a time delay. The cable-net support system is highly compliant with a long natural response time relative to the laminated glass (FIG. 12).

1. A glazing system comprising: a glass laminate glazing element; a support structure for the glazing element; and a connection system to attach the glazing element to the support structure, wherein the glazing element, the support structure, and the connection system are constructed to provide the glazing system with a dynamic response mechanism wherein during and/or after a force impulse wave is applied to the glazing system the connection system absorbs a fraction of the force applied to the glazing element, and dissipates the absorbed portion of the externally applied force such that the absorbed force is converted into non-destructive motion throughout the connection system.

2. The glazing system of claim 1 wherein the laminate comprises a glass laminate of the type used in hurricane glazing.

3. The glazing system of claim 2 wherein the connection system comprises an attachment between the interlayer and the support structure.

4. The laminate of claim 3 wherein the interlayer is an ethylene acid copolymer or a fully or partially neutralized salt thereof.

5. A glazing system comprising: a glazing element; a support structure for the glazing element; and a connection system to attach the glazing element to the support structure, wherein the glazing element, the support structure, and the connection system are constructed to provide the glazing system with a dynamic response mechanism wherein during and/or after a force impulse wave is applied to the glazing system the connection system absorbs a fraction of the force applied to the glazing element, and dissipates the absorbed portion of the externally applied force such that the absorbed force is converted into non-destructive motion throughout the connection system.
